(19) United States
(12) Patent Application Publication
(10) Pub. No.: US 2014/0216768 A1
(43) Pub. Date: Aug. 7, 2014

(54) Fire-Fighting Apparatus

(71) Applicant: Carlos Alberto Fleury Bellandi, Terras De Sao Jose - ITU/SP (BR)

(72) Inventor: Carlos Alberto Fleury Bellandi, Terras De Sao Jose - ITU/SP (BR)

(73) Assignee: GUARANY INDUSTRIA E COMERCIO LTDA, Pirapitingui, CEP - ITU/SP (BR)

(21) Appl. No.: 14/110,067

(22) PCT Filed: Aug. 4, 2011
(86) PCT No.: PCT/BR2011/000278

§ 371 Date: Apr. 16, 2014

(30) Foreign Application Priority Data
Apr. 4, 2011 (BR) PI101515-2

(51) Int. Cl. A62C 15/00

(52) U.S. Cl. CPC A62C 15/00
USPC 169/30

(57) ABSTRACT

The present patent application relates to a fire fighting apparatus comprising an ergonomic setting for simple, fast and safe handling during supply and use even under the most adverse conditions.

### FIELD OF THE INVENTION

The present model relates to a setting applied to a fire-fighting apparatus that can be used in various situations in which access is restricted or there are obstacles which prevent the use of fire hoses and requires the use a portable apparatus which is fast and easy to be supplied.

### BACKGROUND OF THE INVENTION

The reservoirs available in the prior art are made of a PVC (polyvinyl chloride) blanket which is wound and glued to form a cylindrical tube, which brings instability when positioned on the back of the user, hence the need for a plurality of handles to overcome this problem.

Other handling and supply limitations exist due to the configuration of the reservoir that does not allow for an ergonomic grip. Additionally, the type of weld used for sealing makes it more susceptible to breakage, thereby limiting sudden movements that invariably occur in case of fire.

Other limitation refers to the configuration of the reservoir when it is empty. The supply nozzle is positioned in the middle portion, which does not allow full supply when the user has the apparatus in his back and in use position, and also its reduced size does not allow a fast supply.

The present model makes it possible to overcome these limitations of the prior art as it is ergonomic for fast and easy handling for both supply and use in fire fighting, even under the most adverse conditions.

### BRIEF DESCRIPTION OF THE DRAWINGS

FIG. 1 depicts a front view of the apparatus when it is empty.

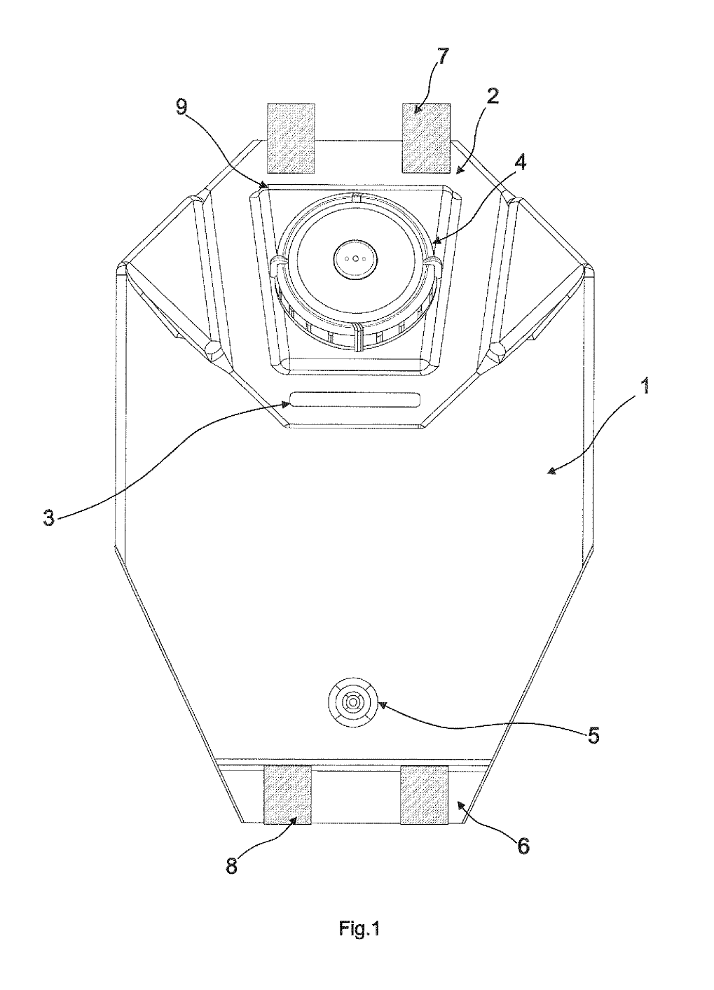

FIG. 2 depicts a back view of the apparatus.

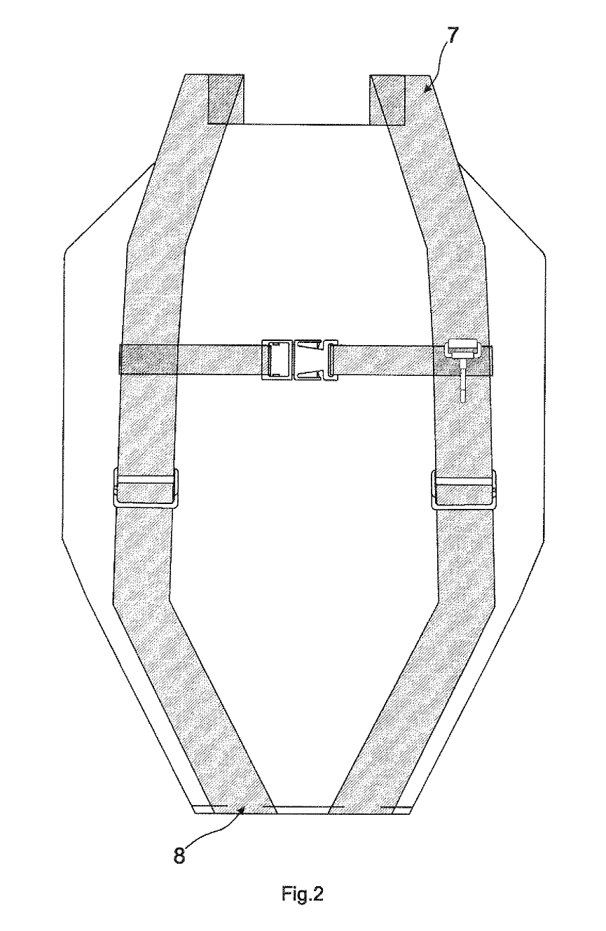

### DETAILED DESCRIPTION

The present model allows to overcome the limitations of the prior art since the present reservoir comprises the use of flexible material, preferably flexible PVC, which is folded and electronically welded.

The reservoir has handles for back support (7) secured on the upper portion (2) and handles (8) secured on the bottom portion (6). The handles are secured by means of seams or electronically welded. A cross belt is placed in position near the chest area of the user, which can be incorporated to provide the user with increased stability. The belt is secured on the right and on the left and has a fast release latch.

In the upper portion (2) of the reservoir, which has a hexagonal shape, a quadrilateral central portion is provided, measuring 0.1 to 2 cm in height, preferably 0.5 cm, comprising a nozzle q(4) electronically welded in its central portion which has a thread for sealing to a lid.

In the bottom portion of the reservoir, a connection is provided for fast closing (5) in the shape of a circle, whose function is the fast coupling and uncoupling of a hose. The connection prevents fluid outflow in case of uncoupling of the hose.

In the inner portion of the reservoir, 1-50 reinforcing structures are provided which are made of flexible material, preferably flexible PVC, which are electronically welded, giving rise to a continuous reinforcing inner structure. Such structures allow the reservoir to keep uniformity when partially or completely filled, since the resistance of the apparatus is increased. Furthermore, it decreases the inner agitation of the fluid, which allows improved mobility to the user.

1. “FIRE-FIGHTING APPARATUS”, characterized in that it comprises a reservoir (1) made of a flexible material, preferably flexible PVC, handles for back support secured on the upper (2) and bottom (6) portions, height-adjustable buckles (number to be inserted when finishing the drawings), a shoulder support (number to be inserted when finishing the drawings), a chest lockable buckle (number to be inserted when finishing the drawings), with a carrying handle (3) having a rectangular shape (3) of 1 cm×20 cm, preferably 2.5 cm×15 cm, a quadrilateral central portion (9) of 0.1 to 2 cm in height, preferably 0.5 cm, comprising an electronically welded nozzle (4) in the upper portion of the reservoir (2) which has an external thread to perfectly fit with the lid, a threaded connection (5) with fast lock to prevent fluid outflow.

2. Apparatus, according to the previous claims, characterized in that the reservoir (1) has an octagonal shape.

3. Apparatus, according to the previous claims, characterized in that the shape of the upper portion of the reservoir (2), where the nozzle and the handles for back support are placed, has a hexagonal shape.

4. Apparatus, according to the previous claims, characterized in that the reservoir joints are electronically welded.

5. Apparatus, according to claim 1, characterized in that the nozzle enables the installation of a removable filter.

6. Apparatus, according to the previous claims, characterized in that the reservoir comprises a threaded connection with a fast lock in the bottom portion to prevent fluid outflow.

7. Apparatus, according to the previous claims, characterized in that the reservoir joints are electronically welded.

8. Apparatus, according to the previous claims, characterized in that it comprises reinforcing structures welded in the inner portion.
